(19) United States
(12) Patent Application Publication
(10) Pub. No.: US 2003/0138210 A1
(43) Pub. Date: Jul. 24, 2003

(54) Optical fiber with collimated output having low back-reflection

(76) Inventors: Dan A. Steinberg, Blacksburg, VA (US); Hui Luo, Scarborough (CA); Jasean Rasnake, Blacksburg, VA (US)

Correspondence Address: Maria M Eliseeva, Brown Rudnick Berlack Israels LLP, One Financial Center, 18th Floor, Boston, MA, 02111, US

(21) Appl. No.: 10/041,517

(22) Filed: Oct. 18, 2001

Related U.S. Application Data
(60) Provisional application No. 60/241,327, filed on Oct. 18, 2000.

(51) Int. Cl. G02B 6/32

(52) U.S. Cl. 385/38; 385/33

(57) ABSTRACT

The present invention provides an optical fiber with a collimated output. The device has exceptionally low back-reflection. The device has an optical fiber with an angled endface. A homogeneous transparent block is disposed on the optical fiber endface. An exit face of the block is perpendicular to the optical axis. Light reflected by the exit face diverges before it reaches the optical fiber, thereby providing low backreflection. A lens can be disposed in the optical axis in front of the block. The present invention can be used with free space optical switches, optical isolators and the like.

### RELATED APPLICATIONS

The present application claims the benefit of priority of copending provisional patent application 60/241,327 filed on Oct. 18, 2000, which is hereby incorporated by reference.

### FIELD OF THE INVENTION

The present invention relates generally to microoptical components, and, more particularly, to free space microoptical devices requiring a collimated input beam.

### BACKGROUND OF THE INVENTION

Many microoptical devices require a collimated input beam. Examples of such devices include free space microoptical switches (e.g. switches with movable micromirrors), multiplexers and demultiplexers. Typically, an optical fiber provides the light beam. Collimating the light beam requires a lens aligned with the fiber endface.

In such devices, it is often desirable to have low back-reflection. Reflection of light into the fiber (e.g. light reflected from the fiber endface) can cause disturbances In optical devices (e.g. lasers) located upstream. It is a challenge to design a collimator that reflects a very small amount of light back into the optical fiber.

### SUMMARY

The present invention provides optical fiber collimators and optical fiber beam directors having very low backreflection. The low backreflections is provided by a block attached to the endface of the optical fiber. The endface of the optical fiber is angled with respect to the optical axis of the device. And exit face of the block is perpendicular to the optical axis, so that the optical axis is straight throughout the device. The present invention can be used in free space optical switches, sensors, and other optical bench components.

### DESCRIPTION OF THE FIGURES

FIG. 1 shows a collimated optical fiber array according to the present invention.

FIG. 2 shows close-up of the invention, illustrating operation of the invention.

FIG. 3 shows an alternative embodiment of the present invention where the lens 36 is disposed on the exit face 32.

FIG. 4 shows a perspective view of a fiber array according to the present invention.

FIG. 5 shows a 2×2 optical crossbar switch device according to the present invention.

FIG. 6 shows a tilting micromirror switch according to the present invention.

FIG. 7 shows an optical nonreciprocal device (e.g. optical isolator) according to the present invention.

### DETAILED DESCRIPTION

The present invention provides an optical fiber with a collimated beam having a very low backreflection. The present invention can be used in switches, multiplexers, demultiplexers or any other device where low backreflection is needed. In the present invention, the optical fiber has an angled endface, and a homogeneous block is disposed on the endface. The output face of the block is perpendicular to the optical axis of the fiber. Significantly, the collimated beam of the present invention is parallel with an optical axis of the optical fiber.

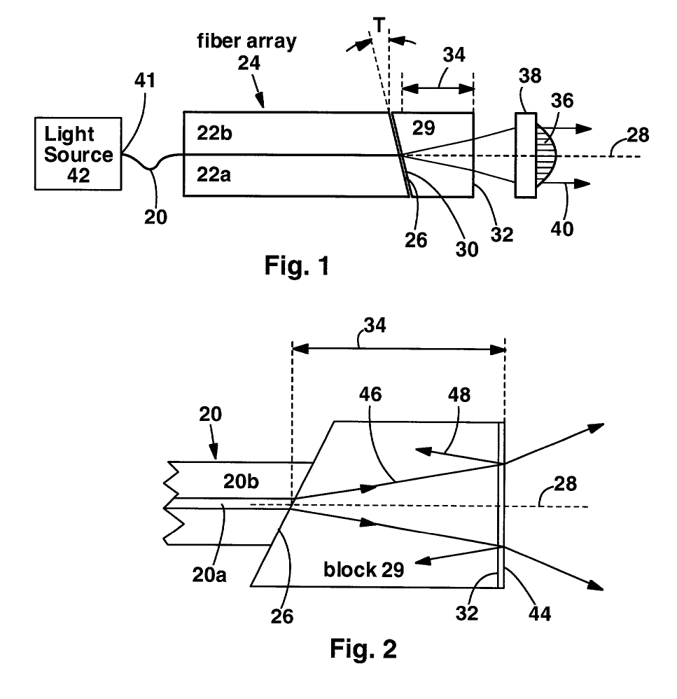

FIG. 1 shows a side view of a collimated fiber array according to the present invention. The collimated fiber array has an optical fiber 20 disposed between V-groove chips 22a, 22b. The optical fiber 20 and V-groove chips comprise a fiber array 24. A endface 26 of the fiber array and optical fiber 20 is nonperpendicular with respect to an optical axis 28. The endface 26 is at an angle T with respect to a plane perpendicular to the optical axis 28. The angle T can be about 2-12 degrees, for example. Preferably, the angle T is great enough so that light reflected from the endface 26 is not coupled into the optical fiber 20.

A transparent, homogeneous block 29 is disposed on the endface 26. The block has an entrance face 30 and an exit face 32. The entrance face 30 is angled at the angle T, so that a gap between the block 29 and endface 26 is relatively flat. The block 29 and endface 26 can be in contact, or can be attached by a thin film of transparent optical adhesive (e.g. epoxy). The exit face 32 is perpendicular to the optical axis 28. An antireflection coating (not shown) may be disposed on the exit face 32.

The transparent block has a thickness 34. The thickness 34 is measured along the optical axis. The thickness 34 can be about 0.2 mm to about 5 mm, for example. The transparent block can be made of glass, silicon, or other transparent materials. The block 29 necessarily has a homogeneous index of refraction; it is not a graded-index (GRIN) lens. Preferably, the refractive index of the block matches the refractive index of the optical fiber core (typically about 1.46 for silica fiber). The transparent block can have a refractive index within about 5% of the index of the fiber core, for example, although refractive indexes outside this range are usable in the invention.

A lens 36 is disposed in front of the block 29 and aligned with the optical axis 28. The lens maybe disposed on a lens substrate 38. The lens 36 and substrate 38 may be in contact with the block 29, or may be spaced apart, as shown. In the device shown in FIG. 1, the lens 36 is located so that a relatively collimated beam 40 is provided. It is noted that the optical axis 28 is parallel with the collimated beam and parallel with the optical fiber 20. This is significant in that it allows the beam 40 to be directed by mechanical connection to the fiber array 24.

The lens 36 can be a refractive lens (as shown) or it can be a GRIN lens, holographic lens, or any other kind of lens.

Finally, a light source 42 is connected to the optical fiber 20 at an input 41 so that light can be directed from the input 41, through the fiber 20, block 29 and lens 36, in that order. The light source can be a laser, waveguide, optical fiber or any other device that provides or directs light into the fiber 20.

FIG. 2 shows a close-up of the optical fiber 20 and the block 29, illustrating the operation of the present invention. The chips 22a, 22b are not shown. The optical fiber 20 has a core 20a and a cladding 20b. An antireflection coating 44 is disposed on the exit face 32 of the block 29.

Light 46 exits the optical fiber core 20a and enters the block 29. A small amount of light (not shown) is reflected at the endface 26. Since the endface 26 is nonperpendicular to the optical axis 28, the reflected light is not coupled into the optical fiber core 20a. Also, since the block 29 and optical fiber core 20a have the same refractive indexes, the optical axis 28 is not bent by the fiber-block interface.

Light 46 passes through the block 29 and exits the exit face 32. A small amount of light 48 is reflected by the exit face 32. The reflected light 48 diverges as it passes through the block 29. Therefore, when the reflected light reaches the optical fiber core 20a, only a small amount is coupled into the fiber core. Most of the reflected light 48 misses the core 20a and the fiber 20. This provides low backreflection for the collimator of the present invention. Since the reflected light 48 is divergent, increasing the block thickness 34 reduces the backreflection.

The light 46 that exits the block 29 is aligned with the optical axis.

The backreflection loss provided by the block 29 is in addition to backreflection loss provided by the angled endface 26, and the antireflection coating 44. The backreflection loss contribution of the block 29 can be approximately calculated from the following equation (assuming a Gaussian beam profile):

$$Loss due to Block = \frac{4}{4 + {( \frac{2 L}{{Z}_{R}} )}^{2}}$$

Where L is the thickness 34, and Z_{R} is the Rayleigh range of the beam in the glass block. L and Z_{R} are expressed in the same units. For example, for single mode fiber (e.g. SMF 28) at a wavelength of 1550 nm, the Rayleigh range is about 76 microns. As a further example, backreflection reductions for certain block thicknesses are given in the table below.

Backreflection attenuation for single mode fiber at 1550 nm

| Thickness 34 of block | Backreflection reduction |
|---|---|
| 1 mm | 22 dB |
| 2 mm | 28 dB |
| 4 mm | 34 dB |

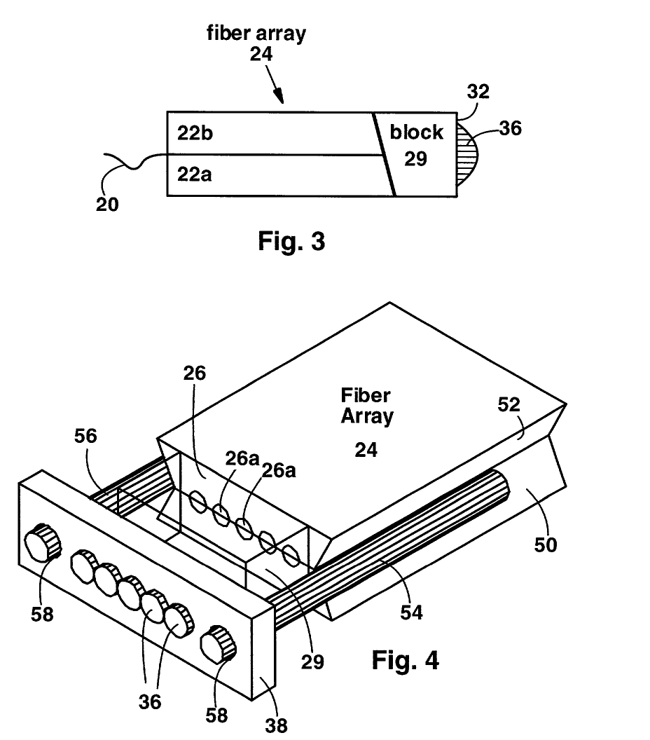

FIG. 3 shows an alternative embodiment of the present invention where the lens 36 is disposed on the exit face 32. In this case, an antireflection coating can be deposited over the lens surface. The embodiment of FIG. 3 proivides an accurate distance between the lens 36 and the fiber.

FIG. 4 shows an embodiment of the invention having 5 optical fibers and 5 lenses 36 aligned with the fibers. Only the endfaces 26a of the optical fibers are visible. A single block 29 is used for all 5 fibers, although several blocks could be used for individual fibers or small groups of fibers. The fiber array 24 has angled sides 50, 52 for engaging alignment pin 54. Similarly, alignment pin 56 is in contact with angled sides (not visible). The angled sides 50, 52 can be formed by anisotropic wet etching of silicon, for example, as known in the art of making mechanical-transfer optical fiber connectors. The pins 54, 56 extend through holes 58 in the substrate 38, thereby providing alignment between the fibers and the lenses 36.

The present invention can be used in many different optical devices that require collimated beams with low backreflection.

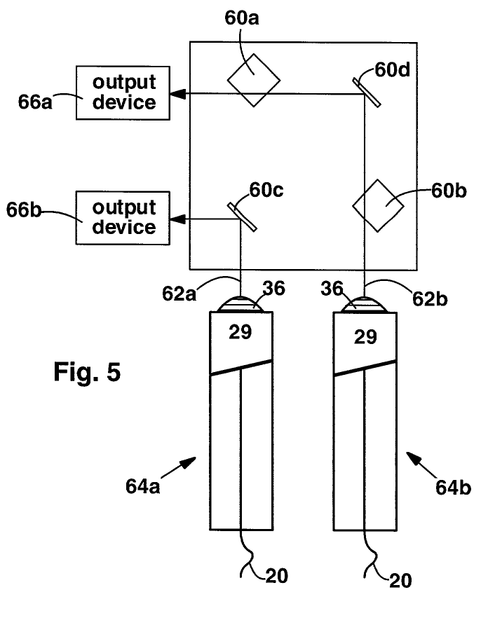

FIG. 5, for example, shows a top view of an optical crossbar 2×2 switch according to the invention having flip-up micromirrors 60 for controlling collimated light beams 62a 62b. Light beams 62 come from collimators 64a 64b described herein. Mirrors 60a, 60b are lying flat, out of the light beam 62. Mirrors 60c 60d are in an upright position, and therefore reflect the light beams 62. Beams 62 are directed to output devices 66a 66b, which can be light detectors, filters, multiplexers, fibers or any other optical device. The collimators 64 provide collimated light beams that are simple to align with respect to the micromirrors 60. The beams are simple to align because the beams are parallel with the optical fibers 20.

Although the collimator units are shown in FIG. 5 as discrete units (each with one fiber), an arrayed device as shown in FIG. 4 can be used so that all the beams are from a single device having several fibers and several lenses (and a single block 29).

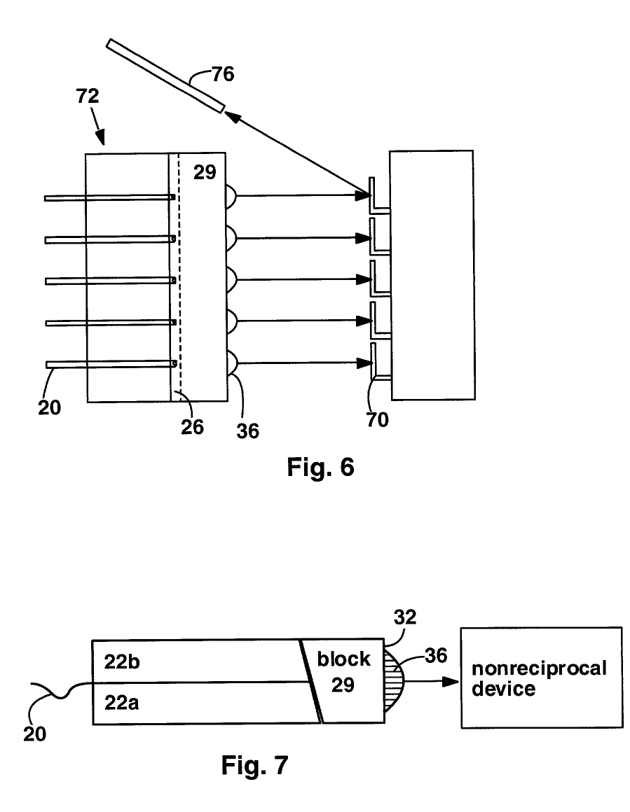

FIG. 6 shows an optical switch according to the present invention having tiltable micromirrors 70. The endface 26 is seen nearly edge-on in FIG. 6. An array of collimators 72 according to the present invention is directed at the tiltable micromirrors 70. The micromirrors can tilt to direct the beams 74 to output fibers 76 or other output devices (not shown). The lens 36 can be selected so that the beam if focused on the output device (e.g. fiber 76).

FIG. 7 shows an optical nonreciprocal device (e.g. optical isolator, optical circulator) according to the present invention. Optical nonreciprocal devices typically require a light input device with very low backreflection. The present collimator can provide an optical beam for an optical nonreciprocal device such as an optical isolator. The low backreflection of the present device assures that the nonreciprocal device does not have backreflections arising from the optical fiber input.

The present invention can be used with single-mode and multi-mode fibers. It is noted that the backreflection loss calculations will be different for single-mode and multimode fibers.

Although the invention has been described using fibers disposed in V-groove chips, it is not necessary to use V-groove chips in the present invention. The optical fibers can be disposed in tubes or ferrules instead of V-groove chips.

The block 29 can be made of many different materials including glass, plastic, semiconductors (e.g. silicon), and the like. The exit face 32 does not need to be precisely perpendicular to the optical axis 28; the exit face 32, can be a couple degrees off perpendicular from the optical axis 28, as an exit face 32 with precise perpendicularity can be difficult to manufacture.

It will be clear to one skilled in the art that the above embodiment may be altered in many ways without departing from the scope of the invention. Accordingly, the scope of the invention should be determined by the following claims and their legal equivalents.

What is claimed is:

1. An optical fiber collimator apparatus with low backreflection, comprising:
a) an optical fiber having an angled, planar endface, and an input on the opposite end of the fiber from the planar endface, and wherein the optical fiber has an optical axis;
b) a homogeneous, transparent block disposed on the endface, wherein the block has an entrance face parallel with the angled planar endface of the optical fiber, and wherein the block has an exit face perpendicular to the optical axis and opposite the optical fiber;
c) a light source optically coupled to the input of the optical fiber;
and wherein a light beam produced by the light source exits the exit face in a direction parallel with the optical axis of the optical fiber.

2. The apparatus of claim 1 further comprising an optical device disposed so that the light beam is incident on the optical device after passing through the block.

3. The apparatus of claim 3 wherein the optical device is selected from the group consisting of photodetectors, movable micromirrors, filters, and nonreciprocal optical devices.

4. The apparatus of claim 3 further comprising a lens disposed between the block and the optical device.

5. The apparatus of claim 1 wherein the optical fiber endface has an angle with respect to a plane perpendicular to the optical fiber axis in the range of about 1-20 degrees.

6. The apparatus of claim 1 further comprising an antireflection coating on the exit face.

7. The apparatus of claim 1 wherein the block has a thickness in the range of about 0.2 mm to 5 mm.

8. The apparatus of claim 1 wherein the optical fiber has a core, and wherein the block has a refractive index equal to the refractive index of the optical fiber core to within 5%.

9. The apparatus of claim 1 wherein the optical fiber is disposed between two V-groove chips, and further comprising:
a) angled sides on the V-groove chips;
b) an alignment pin in contact with the angled sides, and extending in a direction roughly parallel with the optical axis;
c) a substrate attached to the lens, wherein the substrate has a hole, and an alignment pin extends through the hole.

10. The apparatus of claim 1 further comprising a second fiber having a second angled, planar endface, and an input on the opposite end of the fiber from the planar endface, wherein the second angled, planar endface is in contact with the block, and wherein the second fiber is parallel with the optical fiber.

11. The apparatus of claim 1 further comprising a movable micromirror disposed so that the light beam from the optical fiber is incident on the movable micromirror after passing through the block.

12. The apparatus of claim 11 wherein the micromirror is a flip-up micromirror.

13. The apparatus of claim 11 wherein the micromirror is a tiltable micromirror.

14. The apparatus of claim 1 further comprising a lens disposed on the optical axis for receiving the light beam after passing through the block.

15. An optical fiber apparatus with low backreflection, comprising:
a) an optical fiber having an angled, planar endface, and an input face on the opposite end of the fiber from the planar endface, and wherein the optical fiber has an optical axis;
b) a homogeneous, transparent block disposed on the endface, wherein the block has an entrance face parallel with the angled planar endface of the optical fiber, and wherein the block has an exit face perpendicular to the optical axis and opposite the optical fiber;
c) a lens disposed on the optical axis for receiving light from the optical fiber;
d) an optical device disposed so that a light beam from the optical fiber is incident on the optical device after passing through the block and the lens.

16. The apparatus of claim 15 wherein the optical device is a flip-up micromirror.

17. The apparatus of claim 15 wherein the optical device is a tiltable micromirror.

18. The apparatus of claim 15 wherein the optical device is a nonreciprocal optical device.

19. The apparatus of claim 15 wherein the optical device is a photodetector.

20. The apparatus of claim 15 further comprising a light source optically coupled to the input of the optical fiber.

21. An optical fiber apparatus with low backreflection, comprising:
a) an optical fiber having an angled, planar endface, and an input face on the opposite end of the fiber from the planar endface, and wherein the optical fiber has an optical axis;
b) a homogeneous, transparent block disposed on the endface, wherein the block has an entrance face parallel with the angled planar endface of the optical fiber, and wherein the block has an exit face perpendicular to the optical axis and opposite the optical fiber;
c) a lens disposed on the exit face for receiving a light beam from the optical fiber.

22. The apparatus of claim 21 further comprising a light source optically coupled to the input of the optical fiber.

23. The apparatus of claim 21 further comprising an optical device disposed so that the light beam is incident on the optical device after passing through the block and the lens.

24. The apparatus of claim 23 wherein the optical device is selected from the group consisting of photodetectors, movable micromirrors, filters, and nonreciprocal optical devices.
